(19) United States
(12) Patent Application Publication
(10) Pub. No.: US 2008/0168923 A1
(43) Pub. Date: Jul. 17, 2008

(54) Black Dye Ink for Ink-Jet Recording

(75) Inventors: Yuko IWAMURA, Nagoya-shi (JP); Kazuma GOTO, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/971,231

(22) Filed: Jan. 9, 2008

(30) Foreign Application Priority Data
Jan. 11, 2007 (JP) 2007-003666
Dec. 20, 2007 (JP) 2007-329239

(51) Int. Cl. C09D 11/02

(52) U.S. Cl. 106/31.13

(57) ABSTRACT

A black dye ink for ink-jet recording containing a black dye, a color dye for toning, a water-soluble organic solvent and water, satisfies the following inequalities (1) and (2) simultaneously:

ODimax(0)−ODimin(0)≦0.15, and (1)

ODimax(1)−ODimin(1)≦0.15, (2)
where ODimax(0) and ODimin(0) are maximum and minimum optical densities, respectively, of ODiy(0), ODim(0) and ODic(0) which are the optical densities of Y, M and C color components, respectively, of a solid black printed portion printed on glossy paper with the black dye ink and having an average optical density of about 0.9 or more and about 1.1 or less; and
ODimax(1) and ODimin(1) are maximum and minimum optical densities, respectively, of ODiy(1), ODim(1) and ODic(1) which are the optical densities of the Y, M and C color components, respectively, after a predetermined light fastness test is performed on the solid black printed portion.

### CROSS REFERRENCE TO RELATED APPLICATION

The present invention claims priorities from Japanese Patent Application Nos. 2007-003666 and 2007-329239, which were filed on Jan. 11, 2007 and Dec. 20, 2007, respectively, the disclosures of which are herein incorporated by reference in their entirety.

### BACKGROUND OF THE INVENTION

1. Field of the Invention

The present invention relates to a black dye ink for ink-jet recording.

2. Description of the Related Art

Conventionally, a black dye ink which uses a single black dye for ink-jet recording has been widely used. When a solid black printed object printed with such a black dye ink on glossy paper is measured for the optical density of each of a yellow (Y) color component, a magenta color (M) component and a cyan (C) color component, the optical density is generally different for each of the color components, as shown in FIG. 3. Therefore, the solid black printed object printed with a black dye ink for ink-jet recording in which only a single black dye is used represents a bluish black color when, for example, the Y color component is weak relative to the other color components, as shown in FIG. 3.

To obtain a black color that is as close to an achromatic color as possible, a technique has been proposed. Specifically, dyes of colors each corresponding to a color component with insufficient optical density are added to a black dye to tone its color such that the optical densities of the Y, M and C color components of a solid black object printed with a black ink are substantially the same (see FIG. 4). Of course, an object printed with such a toned black dye ink for ink-jet recording exhibits good color balance (being the balance between the optical densities of the Y, M and C color components of the solid black object).

However, when a printed object produced using the toned black dye ink prepared as described above is irradiated with sunlight or light from a fluorescent tube, the colors of the dyes fade, and the optical density of the printed object is reduced. In this case, so long as the color balance is maintained, the color fading is less likely to be noticeable even when the optical density of the printed object is reduced. In practice, the degree of reduction in optical density is different for each of the Y, M and C color components. In addition, the color of each of the color dyes used for toning of black color also fades. As described above, in the toned black dye ink, not only is the optical density of the printed object after irradiation with light reduced, but the color balance of the printed object is also greatly disturbed.

### SUMMARY

It is an object to provide good color balance both before and after color fading due to light in an object printed with a toned black dye ink for ink-jet recording including a black dye, a color dye for toning, a water-soluble organic solvent and water.

The present inventors have prepared a toned black dye ink for ink-jet recording including the above-described components. The inventors have then performed a light fastness test on a solid black printed portion printed on glossy paper with the toned black dye ink and have measured the optical densities of the Y, M and C color components of the solid black printed object. The inventors have found that the above object may be achieved by adjusting the difference between the maximum and minimum values of the optical densities of the three components such that the difference is equal to or less than a predetermined value both before and after the light fastness test is performed. In this case, the difference in optical density before and after the light fastness test is not reduced in a simple manner.

An aspect of the present invention provides a black dye ink for ink-jet recording comprising a black dye, a color dye for toning, a water-soluble organic solvent and water, wherein
in a solid-printed portion printed on glossy paper with the black dye ink and having an average optical density of about 0.9 or more and about 1.1 or less, the following inequalities (1) and (2) are satisfied simultaneously:

ODimax(0)−ODimin(0)≦0.15 (1)

ODimax(1)−ODimin(1)≦0.15 (2)
where ODimax(0) and ODimin(0) are a maximum optical density and a minimum optical density, respectively, of ODiy(0), ODim(0) and ODic(0) which are optical densities of yellow, magenta and cyan color components, respectively; and
ODimax(1) and ODimin(1) are a maximum optical density and a minimum optical density, respectively, of ODiy(1), ODim(1) and ODic(1) which are optical densities of the yellow, magenta and cyan color components, respectively, after a predetermined light fastness test is performed on the solid-printed portion printed with the black dye ink.

### BRIEF DESCRIPTION OF THE DRAWINGS

FIG. 1 is a diagram of an optical density, (A) in FIG. 1 being a diagram of the optical density for each color component in a solid-printed object printed with a black dye solution in which a single black dye is used, (B) in FIG. 1 being a diagram of the optical density for each color component in a solid-printed object printed with a black dye ink in which a yellow dye and a magenta dye, in combination with a black dye, are used as the color dyes for toning, (C) in FIG. 1 being a diagram of the optical density after a light fastness test was performed for each color component in the solid-printed object printed with the black dye ink in which the yellow ink and the magenta ink, in combination with the black dye, are used as the color dyes for toning.

FIG. 2 is a chart of an absorbance curve of a black dye.

FIG. 3 is a diagram describing the optical density of each color component in a solid-printed object printed with a black dye ink for ink-jet recording in which a single black dye is used.

FIG. 4 is a diagram describing the optical density of each color component in a solid-printed object printed with an ink in which yellow and magenta dyes serving as color dyes for toning are used in combination with a black dye.

### DETAILED DESCRIPTION OF THE PREFERRED EMBODIMENTS

A black dye ink for ink-jet recording contains a black dye, a color dye for toning, a water-soluble organic solvent and water, and is characterized in that the following inequalities (1) and (2) are satisfied simultaneously:

ODimax(0)−ODimin(0)≦0.15 (1)

ODimax(1)−ODimin(1)≦0.15 (2)

In inequalities (1) and (2), ODimax(0), ODimin(0), ODimax(1) and ODimin(1) represent the optical densities described below. Specifically, in a solid black printed portion printed on glossy paper with the black dye ink and having an average optical density of about 0.9 or more and about 1.1 or less, the optical densities of the Y, M and C color components are denoted by ODiy(0), ODim(0),and ODic(0), respectively. Then, maximum and minimum optical densities of ODiy(0), ODim(0) and ODic(0) are denoted by ODimax(0) and ODimin(0), respectively. Furthermore, a predetermined light fastness test is performed on the solid-printed portion printed with the black dye ink, and the optical densities of the Y, M and C color components after the test is performed are denoted by ODiy(1), ODim(1) and ODic(1), respectively. Then, maximum and minimum optical densities of ODiy(1), ODim(1) and ODic(1) are denoted by ODimax(1) and ODimin(1), respectively.

For reference, the definitions of the optical densities in the solid-printed portion printed with the black dye ink are listed below.
ODiy(0): the initial (pre-test) optical density of the Y color component of the solid-printed portion printed with the black dye ink
ODim(0): the initial (pre-test) optical density of the M color component of the solid-printed portion printed with the black dye ink
ODic(0): the initial (pre-test) optical density of the C color component of the solid-printed portion printed with the black dye ink
ODimax(0): the initial (pre-test) maximum optical density of the solid-printed portion printed with the black dye ink
ODimin(0): the initial (pre-test) minimum optical density of the solid-printed portion printed with the black dye ink
ODiy(1): the post-test optical density of the Y color component of the solid-printed portion printed with the black dye ink
ODim(1): the post-test optical density of the M color component of the solid-printed portion printed with the black dye ink
ODic(1): the post-test optical density of the C color component of the solid-printed portion printed with the black dye ink
ODimax(1): the post-test maximum optical density of the solid-printed portion printed with the black dye ink
ODimin(1): the post-test minimum optical density of the solid-printed portion printed with the black dye ink

For example, as the light fastness test, a test may be employed in which a solid-printed portion printed with a black dye ink or a black dye solution is irradiated with light for 100 hours at a temperature of 25° C., a humidity of 50% RH and an illuminance of 93 klux, with the used light being generated by a xenon lamp, made to pass through a glass-based filter which blocks light with a wavelength of 320 nm or less, and is then projected onto the solid-printed portion. The test may be performed by means of a high energy xenon weather meter SC780-WN (product of Suga Test Instruments Co., Ltd.). The optical density measurement may be performed by means of Spectrolino (product of Gretag Macbeth, light source: D₆₅; viewing angle: 2°; status A). In this instance, the “status A” represents spectral sensitivity characteristics according to ISO 5/3.

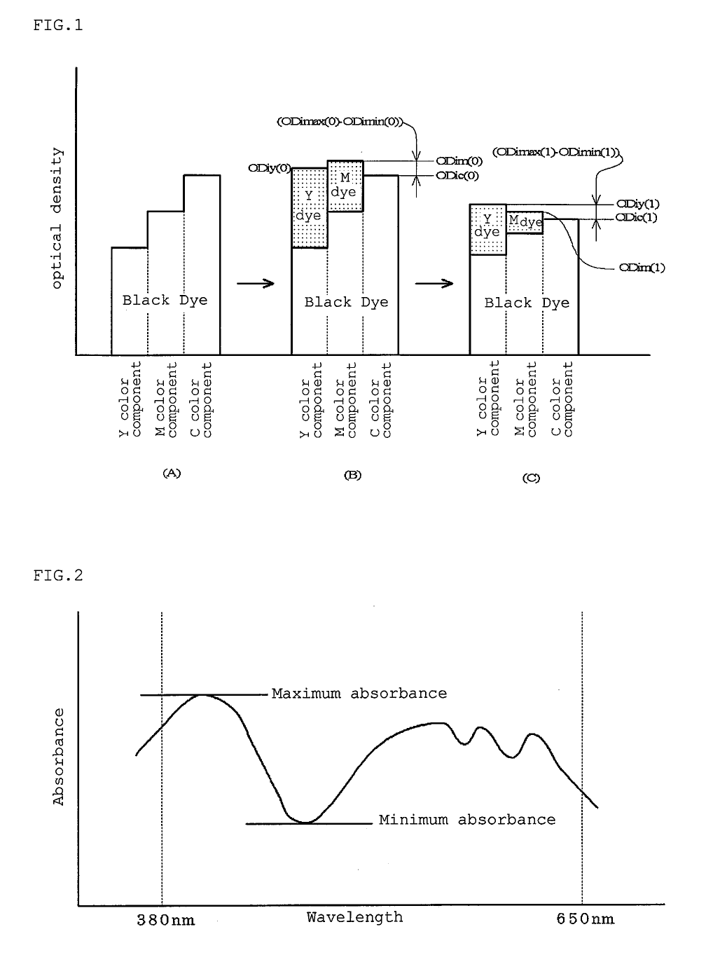

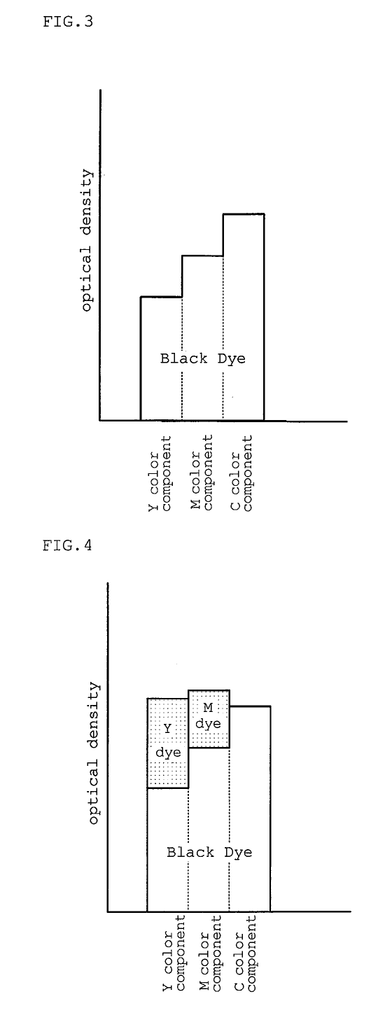

The mutual relationships between ODimax(0), ODimin(0), ODimax(1) and ODimin(1) are shown in FIG. 1. (A) in FIG. 1 is a diagram describing the optical densities of the Y, M and C color components in a solid-printed object printed on glossy paper with a black dye solution in which only a single black dye is used as the coloring agent. In the optical density of this printed object, the Y color component is highly insufficient with respect to the C color component, and the M color component is insufficient with respect to the C color component. This printed object represents a bluish black color. The term “glossy paper” refers paper having a coating layer for imparting surface smoothness to the base paper (body paper). The reason for using the glossy paper is that the degree of ink bleeding is low after printing and vivid color may be obtained. Examples of the glossy paper include, without limitation, photo glossy paper (BP61GLA, product of Brother Industries, Ltd.); premium photo glossy paper of color ink-jet paper (product of Oji paper Co., Ltd.); high fineness photo output ultra glossy paper for ink-jet printer (product of KOKUYO Co., Ltd.); Photo-like QP “photo quality” series (product of KONICA MINOLTA HOLDINGS, INC.); Photo Finishing Pro and Photo Finishing Advance of KASSAI® series and FUJI film premium glossy paper (products of FUJI Film Co., Ltd.); and the like. Because it is considered that, when the optical density of a solid-printed portion printed with a black dye ink is close to 1.0, the density of a printed object may range from light to dark, a portion having an initial (pre-test) average optical density ((ODiy(0)+ODim(0)+ODic(0))/3) of 0.9 or more and 1.1 or less is utilized. A portion having an initial (pre-test) average optical density of 0.9 or more and 1.1 or less may be obtained by, for example, adjusting gray scale of a solid-printed object.

As shown in (B) in FIG. 1, a yellow dye and a magenta dye each serving as the dye for toning are used in combination with the black dye. Accordingly, the optical densities of the Y and M color components are adjusted to a level similar to the optical density of the C color component, which has the highest optical density. In this manner, the color balance of a printed object before the light fastness test is performed is improved. The difference between any two of ODiy(0), ODim(0) and ODic(0) is always 0.15 or less. When the difference exceeds 0.15, the color balance is broken to an unacceptable level. In (B) in FIG. 1, ODimax(0) is ODim(0) which is the optical density of the M color component, and ODimin(0) is ODic(0) which is the optical density of the C color component.

Even when the predetermined light fastness test is performed on the solid-printed portion printed with the black dye ink, the difference between any two of ODiy(1), ODim(1) and ODic(1) is always 0.15 or less, as shown in (C) in FIG. 1. When the difference exceeds 0.15 , the color balance is broken to an unacceptable level. In (C) in FIG. 1, ODimax(1) is ODiy(1) which is the optical density of the Y color component, and ODimin(1) is ODic(1) which is the optical density of the C color component. Therefore, excellent color balance may be achieved both before and after the light fastness test is performed.

In the black dye ink, it is suitable that, in a solid-printed portion which is printed on glossy paper with a black dye solution containing the black dye, the water-soluble organic solvent and water where the black dye solution does not contain the color dye for toning which is one of the constitutional components of the black dye ink, the black dye to be contained in the black dye ink is a black dye contained in the black dye solution being such that a color component giving ΔODdmax agrees with a color component giving ODdmax(0), where ODdmax(0) is the maximum optical density of ODdy(0), ODdm(0) and ODdc(0) which are the optical densities of the Y, M and C color components, respectively, and where ΔODdmax is a maximum optical density difference value of ΔODdy, ΔODdm and ΔODdc defined by the following equations (3) to (5):

ΔODdy=ODdy(0)−ODdy(1) (3)

ΔODdm=ODdm(0)−ODdm(1) (4)

ΔODdc=ODdc(0)−ODdc(1) (5)

where ODdy(1), ODdm(1) and ODdc(1) are the optical densities of the Y, M and C color components, respectively, after a predetermined light fastness test is performed on the solid-printed portion printed with the black dye solution.

The black dye as explained above is such that, among the Y, M and C color components of the black dye, a color component giving the highest optical density before the light fastness test is most likely to fade. Therefore, the color balance after color fading may be improved. In other words, assuming that a color component giving the highest optical density before the light fastness test is least likely to fade, then, after the light fastness test is performed, the optical density of this color component remains significantly high relative to the optical densities of the other color components. This causes difficulty in maintaining the color balance. Various black dyes may be used as the black dye for the black dye ink, and many of them represent a cyanish black color. Hence, it is suitable that the color component giving ΔODdmax provides a large reduction ratio of the optical density for the C color component.

The black dye solution suitably used is a black dye solution obtained by removing the color dye for toning from the composition of the black dye ink and uniformly mixing the composition thus obtained. In this instance, water, water-soluble organic solvent or a combination thereof may be suitably added to the black dye solution in an amount corresponding to an amount of the removed color ink for toning, whereby evaluation tests of the black dye solution may be conducted without remarkably varying a concentration of the black dye with respect to such a concentration of the black dye ink. In addition, upon selection of a solid-printed portion printed with the black dye solution, it is suitably to select a solid-printed portion in which the greatest optical density of optical densities of the Y, M and C color components is about 0.9 or more and about 1.1 or less, whereby comparison between the black dye solution and the black dye ink may be easily conducted in respect of evaluation tests. When the greatest optical density of optical densities of the Y, M and C color components does not reach about 0.9, for example, a concentration of the black dye is allowed to increase or gray scale of a printed object is allowed to be adjusted, so that the greatest optical density may be within a range of about 0.9 or more and about 1.1 or less.

For reference, the definitions of the optical densities in the solid-printed portion printed with the black dye solution are listed below.
ODdy(0): the initial (pre-test) optical density of the Y color component of the solid-printed portion printed with the black dye solution
ODdm(0): the initial (pre-test) optical density of the M color component of the solid-printed portion printed with the black dye solution
ODdc(0): the initial (pre-test) optical density of the C color component of the solid-printed portion printed with the black dye solution
ODdmax(0): the initial (pre-test) maximum optical density of the solid-printed portion printed with the black dye solution
ODdy(1): the post-test optical density of the Y color component of the solid-printed portion printed with the black dye solution
ODdm(1): the post-test optical density of the M color component of the solid-printed portion printed with the black dye solution
ODdc(1): the post-test optical density of the C color component of the solid-printed portion printed with the black dye solution
ΔODdy: the difference in optical density of the Y color component of the solid-printed portion printed with the black dye solution before and after the test is performed
ΔODdm: the difference in optical density of the M color component of the solid-printed portion printed with the black dye solution before and after the test is performed
ΔODdc: the difference in optical density of the C color component of the solid-printed portion printed with the black dye solution before and after the test is performed
ΔODdmax: the maximum optical density difference of the solid-printed portion printed with the black dye solution

When the amount of the black dye is too low, even if the total amount of the black dye and the color dye for toning provides a suitable amount for the black dye ink, it is difficult to form a solid image with a sufficient optical density. Therefore, the amount of the black dye with respect to the total amount of the black dye and the color dye for toning is about 50 wt. % or more.

In the case of the optical density of the C color component in a black dye is the highest and the optical density of the Y color component in a black dye is the lowest, a yellow dye is suitably used as the color dye for toning, and a magenta dye may be used in some cases. In addition, both a yellow dye and a magenta dye may be used together. In some black dyes, the optical density of the C color component may be low relative to that of the others. In such a case, a cyan dye may be used as the color dye for toning. Moreover, when color fading of the black dye itself is significant, yellow, magenta and cyan dyes may be used simultaneously.

The optical density reduction ratios Aiy, Aim and Aic of the Y, M and C color components, respectively, after the light fastness test is performed on the solid-printed portion printed with the black dye ink are defined by equations (6) to (8) below. The Aiy, Aim and Aic are about 20% or less and about 15% or less.

Aiy=[(ODiy(0)−ODiy(1))/ODiy(0)]×100 (6)

Aim=[(ODim(0)−ODim(1))/ODim(0)]×100 (7)

Aic=[(ODic(0)−ODic(1))/ODic(0)]×100 (8)

As described above, the optical density reduction ratio for each of the color components is 20% or less. This means that each of the color components exhibits excellent light fastness. Hence, the excellent color balance before the light fastness test is performed may be maintained after the light fastness test is performed without any substantial change.

For reference, the definitions of the optical density reduction ratios are listed below.
Aiy: the optical density reduction ratio (%) of the Y color component after the light fastness test is performed
Aim: the optical density reduction ratio (%) of the M color component after the light fastness test is performed
Aic: the optical density reduction ratio (%) of the C color component after the light fastness test is performed

The black dye may be understood to refer to any dye in which, when the absorbance of an aqueous solution of the dye is measured over a wavelength range of 380 nm to 650 nm, the minimum absorbance is equal to or greater than 25% of the maximum absorbance (the maximum peak), as shown in FIG. 2. The absorbance may be measured by means of a spectrophotometer such as UV-3600 (product of Shimadzu Corporation). In this case, the aqueous solution of the dye suitably has a dye concentration which gives a maximum absorbance in the range of about 0.50 to about 1.50.

Examples of the black dye which may be used include, without limitation, dyes represented by the general formula (Bk-0) below; C.I. Acid Blacks 2, 7, 24, 26, 31, 52, 63, 112, 118 and the like; C.I. Direct Blacks 17, 19, 32, 51, 71, 108, 146, 154, 168 and the like; C.I. Basic Black 2; C.I. Food Blacks 1 and 2: and the like.

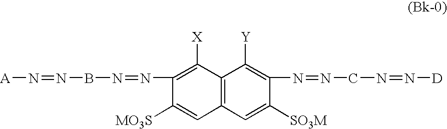

In the general formula (Bk-0), A and D, each independently, represent a substituted or unsubstituted phenyl, or a substituted or unsubstituted naphthyl group, and B and C, each independently, represent a substituted or unsubstituted naphthyl group. Each of A, B, C and D contains at least one sulfo group. One of X and Y represents a hydroxyl group, and the other represents an amino group. M represents a hydrogen atom, an alkali metal, a cation of an organic amine or an ammonium ion. Among the black dyes represented by the general formula (Bk-0), black dyes represented by the chemical formulas (Bk-1) and (Bk-2) may be particularly suitably used because they exhibit a small optical density reduction ratio.

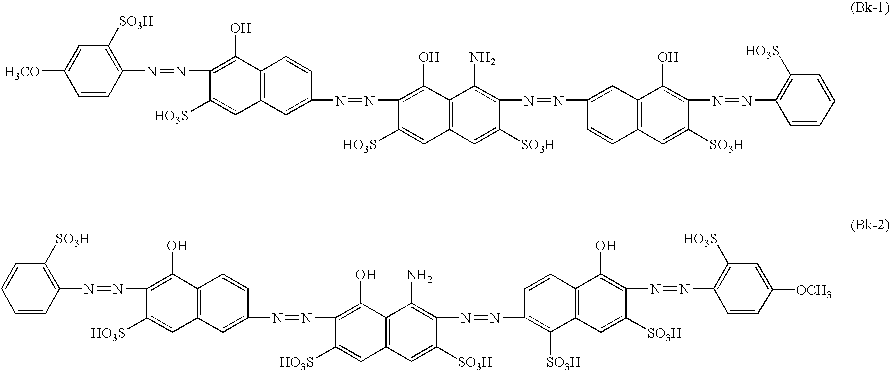

Examples of the color dye for toning include, without limitation, yellow dyes such as C.I. Direct Yellows 12, 24, 26, 27, 28, 33, 39, 58, 86, 98, 100, 132, 142 and 169, C.I. Acid Yellows 3, 11, 17, 19, 23, 25, 29, 38, 42, 49, 59, 61, 71 and 72, C.I. Basic Yellow 40, C.I. Reactive Yellow 2, and the like; and magenta dyes such as dyes represented by the general formulas (M-0) and (M-00), C.I. Direct Reds 4, 17, 28, 37, 63, 75, 79, 80, 81, 83 and 254, C.I. Acid Reds 1, 6, 8, 18, 32, 35, 37, 42, 52, 85, 88, 115, 133, 134, 154, 186, 249, 289 and 407, C.I. Basic Reds 9, 12 and 13, C.I. Reactive Reds 4, 23, 24, 31 and 56, and the like. In addition, cyan dyes such as C.I. Direct Blues 1, 6, 8, 15, 22, 25, 71, 76, 80, 86, 87, 90, 106, 108, 123, 163, 165, 199 and 226, C.I. Acid Blues 9, 22, 29, 40, 59, 62, 93, 102, 104, 112, 113, 117, 120, 167, 175, 183, 229 and 234, C.I. Basic Blues 1, 3, 5, 7, 9, 24, 25, 26, 28 and 29, C.I. Reactive Blues 7, 13 and 49, and the like may be used.

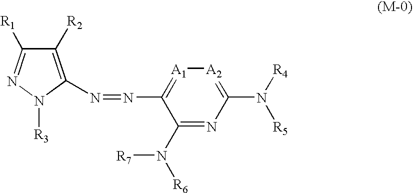

In the general formula (M-0), R₁ represents a hydrogen atom, a substituted or unsubstituted alkyl group, or a substituted or unsubstituted aryl group. R₂ represents a hydrogen atom, a halogen atom or a cyano group. R₃ represents a hydrogen atom, a substituted or unsubstituted alkyl group, a substituted or unsubstituted aryl group, or a substituted or unsubstituted heterocyclic group. R₄, R₅, R₆ and R₇, each independently, represent a hydrogen atom, a substituted or unsubstituted alkyl group, a substituted or unsubstituted aryl group, a substituted or unsubstituted heterocyclic group, a substituted or unsubstituted sulfonyl group, or a substituted or unsubstituted acyl group. Note that R₄ and R₅ are not simultaneously hydrogen atoms, and R₆ and R₇ are not simultaneously hydrogen atoms. A₁ and A₂ are both a substituted or unsubstituted carbon atoms, or one of A₁ and A₂ is a substituted or unsubstituted carbon atom and the other is a nitrogen atom.

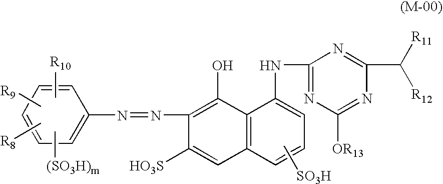

In the general formula (M-00), R₈, R₉ and R₁₀, each independently, represent a substituted or unsubstituted alkyl group, a substituted or unsubstituted alkoxy group, a halogen atom, a hydrogen atom, a hydroxyl group, a substituted or unsubstituted carbamoyl group, a substituted or unsubstituted sulfamoyl group, a substituted or unsubstituted amino group, a nitro group, a sulfonate group, a substituted or unsubstituted alkylsulfonyl group, a substituted or unsubstituted arylsulfonyl group, a carboxyl group or a carboxylate group. The symbol “m” represents a number of 0, 1 or 2, and R₁₁, R₁₂ and R₁₃, each independently, represent a hydrogen atom, a substituted or unsubstituted alkyl group, a substituted or unsubstituted alkenyl group, a substituted or unsubstituted aryl group, a substituted or unsubstituted aralkyl group, a substituted or unsubstituted alicyclic group, or a substituted or unsubstituted heterocyclic group.

Among the magenta dyes represented by the general formulas (M-0) and (M-00), magenta dyes represented by the chemical formulas (M-1) to (M-7) may be particularly suitably used because they exhibit a small optical density reduction ratio.

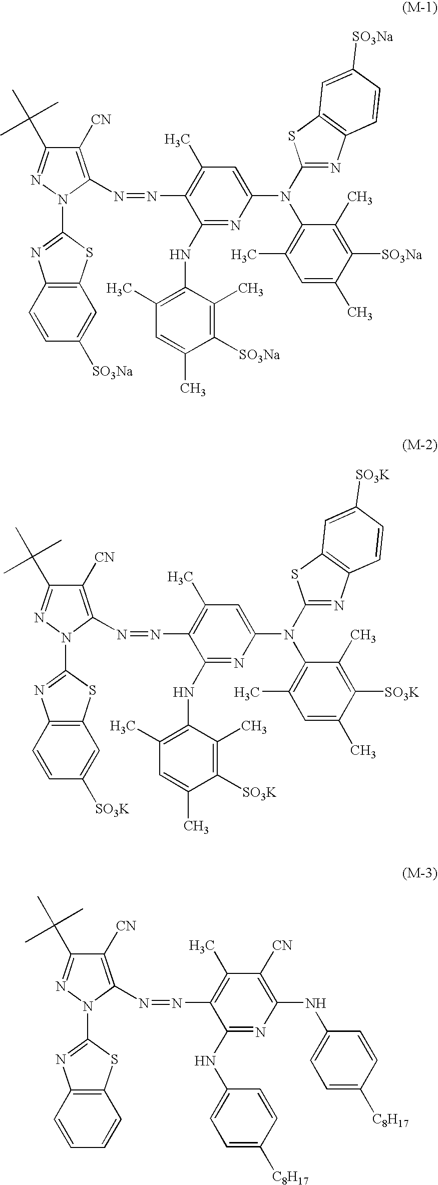

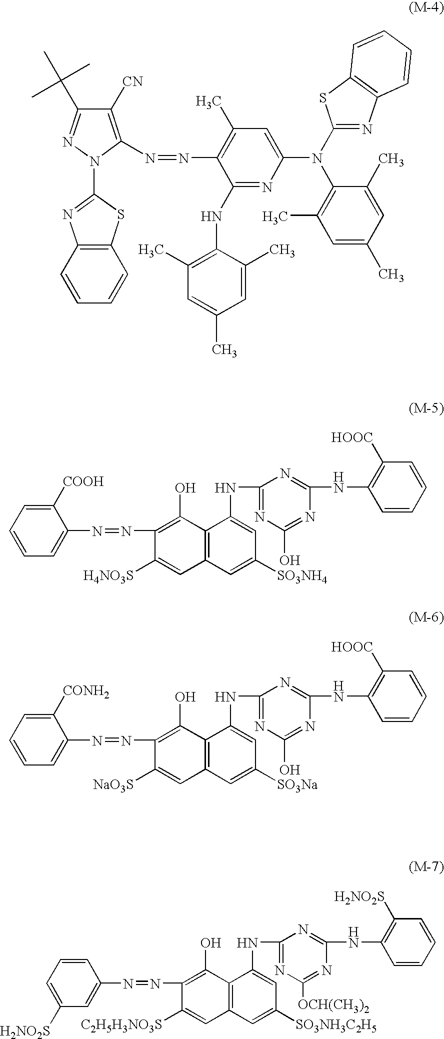

The black dye ink contains, in addition to the black dye and the color dye for toning, a solvent including water and a water-soluble organic solvent.

Suitably, deionized water is used as the water. The suitable amount of water depends on the types and compositions of the water-soluble organic solvent used and the desired properties of the ink and is determined over a wide range. The amount of water with respect to the total amount of the black dye ink is generally in the range of about 10 wt. % to about 95 wt. %, in the range of about 10 wt. % to about 80 wt. % and in the range of about 20 wt. % to about 80 wt. %.

The water-soluble organic solvents are categorized into humectants having the primary effect of preventing drying of the ink in the tip portion of an ink-jet head and penetrants for increasing drying speed on paper. No particular limitation is imposed on the humectants. Examples of the humectants include, without limitation, lower alcohols such as methyl alcohol, ethyl alcohol, n-propyl alcohol, isopropyl alcohol, n-butyl alcohol, sec-butyl alcohol and tert-butyl alcohol; amides such as dimethylformamide and dimethylacetamide; ketones and keto-alcohols such as acetone and diacetone alcohol; ethers such as tetrahydrofuran and dioxane; polyalkylene glycols such as polyethylene glycol and polypropylene glycol; alkylene glycols such as ethylene glycol, propylene glycol, butylene glycol, diethylene glycol, triethylene glycol, dipropylene glycol, tripropylene glycol, thiodiglycol and hexylene glycol; glycerin; 2-pyrrolidone; N-methyl-2-pyrrolidone; 1,3-dimethyl-2-imidazolidinone; and the like. Of these, alkylene glycols and polyalcohols such as glycerin are preferred.

The amount of the humectant with respect to the total amount of the black dye ink is generally in the range of 0 wt. % to about 95 wt. %, in the range of about 5 wt. % to about 80 wt. % and in the range of about 5 wt. % to about 50 wt. %.

No particular limitation is imposed on the penetrants. Examples of the penetrants include, without limitation, glycol-based ethers such as ethylene glycol methyl ether, ethylene glycol ethyl ether, ethylene glycol propyl ether, diethylene glycol methyl ether, diethylene glycol ethyl ether, diethylene glycol propyl ether, diethylene glycol butyl ether, triethylene glycol methyl ether, triethylene glycol ethyl ether, triethylene glycol propyl ether, triethylene glycol butyl ether, propylene glycol methyl ether, propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether, tripropylene glycol methyl ether, tripropylene glycol ethyl ether, tripropylene glycol propyl ether and tripropylene glycol butyl ether.

When the amount of the penetrant is too large, the penetrability of the ink to paper may become excessively high, and this may cause blurring. The amount of the penetrant with respect to the total amount of the black dye ink is generally in the range of 0 wt. % to about 20 wt. %, in the range of about 0.1 wt. % to about 15 wt. % and in the range of about 0.2 wt. % to about 10 wt. %.

If necessary, the black dye ink may further contain other conventionally known additives such as: viscosity modifiers such as polyvinyl alcohol, polyvinylpyrrolidone and water-soluble resins; surface tension modifiers; mildew proofing agents; pH modifiers; and the like.

The black dye ink may be prepared by uniformly mixing the black dye, the color dye for toning, water and other additives such as the water-soluble organic solvents and removing non-dissolved materials through a filter.

The black dye ink may be filled into a known ink cartridge for an ink-jet printer and may be used for ink-jet recording.

### EXAMPLES

(1) Preparation of Black Dye Inks and Black Dye Solutions

(1-1) Examples 1 to 7 and Comparative Examples 1 to 6

After the components of each of the ink compositions summarized in Table 1 were mixed and stirred, the mixture was filtrated through a membrane filter of a hydrophilic PTFE (polytetrafluoroethylen) type (product of Toyo Roshi Kaisha, Ltd., pore size: 0.2 μm), whereby toned black dye inks for ink-jet recording of Examples 1 to 7 and Comparative Examples 1 to 6 were obtained. In the ink compositions listed in Table 1, black dyes (Bk-1) and (Bk-2) are compounds represented by the chemical formulas (Bk-1) and (Bk-2), respectively, and magenta dyes (M-1) to (M-7) are compounds represented by the chemical formulas (M-1) to (M-7), respectively.

TABLE 1

| | | | Example | | | | | | | Comparative Example | | | | | |
|---|---|---|---|---|---|---|---|---|---|---|---|---|---|---|---|
| | | | 1 | 2 | 3 | 4 | 5 | 6 | 7 | 1 | 2 | 3 | 4 | 5 | 6 |
| Composition of | Black | Black dye (Bk-1) | 2.78 | — | 3.01 | — | — | — | — | 2.84 | — | 2.84 | — | — | — |
| black dye | dye | Black dye (Bk-2) | — | 2.81 | — | 3.21 | — | — | — | — | 2.50 | — | — | — | — |
| ink (wt. %) | | C.I. Acid Black 24 (AB24) | — | — | — | — | — | — | — | — | — | — | 4.69 | — | — |
| | | C.I. Direct Black 19 (DB19) | — | — | — | — | — | — | — | — | — | — | — | 4.81 | — |
| | | C.I. Direct Black 154 (DB154) | — | — | — | — | 4.50 | — | — | — | — | — | — | — | — |
| | | C.I. Food Black 2 (FB2) | — | — | — | — | — | 4.08 | 3.52 | — | — | — | — | — | 3.93 |
| | Color | C.I. Acid Yellow 23 (AY23) | — | — | — | — | — | 0.32 | — | 1.14 | — | — | — | — | — |
| | dye | C.I. Direct Yellow 132 (DY132) | 1.11 | 1.13 | 0.90 | — | 0.19 | — | 1.01 | — | — | — | 0.24 | 0.03 | — |
| | | C.I. Direct Yellow 86 (DY86) | — | — | — | — | — | — | — | — | 1.00 | 1.14 | — | — | 0.52 |
| | | C.I. Direct Yellow 169 (DY169) | — | — | — | 0.64 | — | — | — | — | — | — | — | — | — |
| | | Magenta dye (M-1) | 1.11 | — | — | — | — | — | — | 1.02 | — | — | — | — | — |
| | | Magenta dye (M-2) | — | 0.83 | — | — | — | — | — | — | 1.50 | — | — | — | — |
| | | Magenta dye (M-3) | — | — | — | 1.15 | — | — | — | — | — | 1.02 | — | — | — |
| | | Magenta dye (M-4) | — | — | — | — | — | — | — | — | — | — | — | — | 0.55 |
| | | Magenta dye (M-5) | — | 0.23 | — | — | — | 0.60 | — | — | — | — | — | 0.16 | — |
| | | Magenta dye (M-6) | — | — | 1.09 | — | — | — | 0.47 | — | — | — | — | — | — |
| | | Magenta dye (M-7) | — | — | — | — | 0.31 | — | — | — | — | — | 0.07 | — | — |

| | | | | | | | | | | | | | |
|---|---|---|---|---|---|---|---|---|---|---|---|---|---|
| Glycerin | 35.0 | 35.0 | 35.0 | 35.0 | 35.0 | 35.0 | 35.0 | 35.0 | 35.0 | 35.0 | 35.0 | 35.0 | 35.0 |
| Triethylene glycol butyl ether | 4.0 | 4.0 | 4.0 | 4.0 | 4.0 | 4.0 | 4.0 | 4.0 | 4.0 | 4.0 | 4.0 | 4.0 | 4.0 |
| Surfactant *1 | 0.06 | 0.06 | 0.06 | 0.06 | 0.06 | 0.06 | 0.06 | 0.06 | 0.06 | 0.06 | 0.06 | 0.06 | 0.06 |

| | |
|---|---|
| Water | Balance |

| | | | | | | | | | | | | | |
|---|---|---|---|---|---|---|---|---|---|---|---|---|---|
| Total amount of coloring agents in ink (wt. %) | 5.00 | 5.00 | 5.00 | 5.00 | 5.00 | 5.00 | 5.00 | 5.00 | 5.00 | 5.00 | 5.00 | 5.00 | 5.00 |
| Weight ratio of dyes (black dye/color dyes) | 56/44 | 56/44 | 60/40 | 64/36 | 90/10 | 82/18 | 70/30 | 57/43 | 50/50 | 57/43 | 94/6 | 96/4 | 79/21 |

*1 Polyoxy lauryl (12, 13) ether sodium sulfate (3E. O.)

(1-2) Black Dye Solutions 1 to 6

The same procedure as in Examples and Comparative Examples was repeated except that the amount of each black dye used was 3.0 wt. % and the color dyes for toning were not used, whereby black dye solutions 1 to 6 having corresponding black dye solution compositions summarized in Table 2 were obtained. Note that the amount of increase or decrease of the black dye and the amounts of the unused color dyes for toning were replaced with water. In the compositions of the black dye solutions in Table 2, black dyes (Bk-1) and (Bk-2) are compounds represented by the chemical formulas (Bk-1) and (Bk-2), respectively.

TABLE 2

| | | | Black dye solution | | | | | |
|---|---|---|---|---|---|---|---|---|
| | | | 1 | 2 | 3 | 4 | 5 | 6 |
| Composition of black dye | Black dye | Black dye (Bk- | 3.0 | — | — | — | — | — |
| solution (wt. %) | | 1) | | | | | | |
| | | Black dye (Bk- | — | 3.0 | — | — | — | — |
| | | 2) | | | | | | |
| | | C.I. Acid Black | — | — | — | — | 3.0 | — |
| | | 24 (AB24) | | | | | | |
| | | C.I. Direct | — | — | 3.0 | — | — | — |
| | | Black 19 (DB19) | | | | | | |
| | | C.I. Direct | — | — | — | 3.0 | — | — |
| | | Black 154 | | | | | | |
| | | (DB154) | | | | | | |
| | | C.I. Food Black | — | — | — | — | — | 3.0 |
| | | 2 (FB2) | | | | | | |

| | | | | | | |
|---|---|---|---|---|---|---|
| Glycerin | 35.0 | 35.0 | 35.0 | 35.0 | 35.0 | 35.0 |
| Triethylene glycol butyl | 4.0 | 4.0 | 4.0 | 4.0 | 4.0 | 4.0 |
| ether | | | | | | |
| Surfactant *1 | 0.06 | 0.06 | 0.06 | 0.06 | 0.06 | 0.06 |

| | |
|---|---|
| Water | Balance |

| | | | | | | | |
|---|---|---|---|---|---|---|---|
| Optical density before | Y component | 0.66 | 0.68 | 0.73 | 0.79 | 0.67 | 0.83 |
| light fastness test | (ODdy(0)) | | | | | | |
| | M component | 0.93 | 0.95 | 0.88 | 0.80 | 0.92 | 0.94 |
| | (ODdm(0)) | | | | | | |
| | C component | 1.06 | 1.08 | 1.07 | 1.03 | 0.98 | 1.04 |
| | (ODdc(0)) | | | | | | |
| | ODdmax(0) | C | C | C | C | C | C |
| | component | | | | | | |
| Optical density after | Y component | 0.66 | 0.67 | 0.58 | 0.26 | 0.38 | 0.72 |
| light fastness test | (ODdy(1)) | | | | | | |
| | M component | 0.92 | 0.93 | 0.58 | 0.22 | 0.34 | 0.73 |
| | (ODdm(1)) | | | | | | |
| | C component | 0.97 | 0.98 | 0.58 | 0.19 | 0.29 | 0.71 |
| | (ODdc(1)) | | | | | | |
| Optical density difference | Y component | 0.00 | 0.01 | 0.15 | 0.53 | 0.29 | 0.11 |
| before and after light | (ΔODdy) | | | | | | |
| fastness test | M component | 0.01 | 0.02 | 0.30 | 0.58 | 0.58 | 0.21 |
| | (ΔODdm) | | | | | | |
| | C component | 0.09 | 0.10 | 0.49 | 0.84 | 0.69 | 0.33 |
| | (ΔODdc) | | | | | | |
| | ΔODdmax | C | C | C | C | C | C |
| | component | | | | | | |

*1 Polyoxy lauryl (12, 13) ether sodium sulfate (3E. O.)

(2) Printing of Evaluation Sample

Each of the black dye inks and black dye solutions prepared in (1) was filled into an ink cartridge, and the ink cartridge was attached to a digital multifunction device equipped with an ink-jet printer (DCP-115C, product of Brother Industries, Ltd.). Then, a 16-gray scale gradation sample (black to gray to white) was solid-printed on photo glossy paper (BP61GLA, product of Brother Industries, Ltd.).

(3) Evaluation of the Black Dye Inks

(3-1) Measurement of the Optical Density of Each Color Component Before the Light Fastness Test is Performed

A solid-printed portion printed with each black dye ink and having an average optical density averaged over the Y, M and C color components of about 0.9 or more and about 1.1 or less was selected from the solid-printed portions in the evaluation sample (gradation sample) printed in (2) above and was used as an evaluation sample. Then, the initial (pre-test) optical densities (ODiy(0), ODim(0) and ODic(0)) of the Y, M and C color components, respectively, were measured by means of Spectrolino (product of Gretag Macbeth, light source: D₆₅, viewing angle: 2°, status A). The results obtained are summarized in Table 3.

ODimax(0) and ODimin(0) were determined from the initial (pre-test) optical densities of the Y, M and C color components and were evaluated by the following criteria. The results obtained are summarized in Table 3.

ODimax(0)−ODimin(0)≦0.15 A

0.15<ODimax(0)−ODimin(0)≦0.20 B

0.20<ODimax(0)−ODimin(0)

(3-2) Measurement of the Optical Density of Each Color Component After the Light Fastness Test was Performed

Each of the evaluation samples used in (3-1) above was subjected to a light fastness test by means of a high energy xenon weather meter (SC780-WN, product of Suga Test Instruments Co., Ltd.). Specifically, light generated by a xenon lamp was made to pass through a light source lamp filter made of silica glass, a silica glass-based inner filter and a glass-based outer filter which blocks light with a wavelength of 320 nm or less. The resultant light was projected onto the evaluation sample for 100 hours at a temperature of 25° C., a humidity of 50% RH and an illuminance of 93 klux. After the light fastness test was completed, the post-test optical densities (ODiy(1), ODim(1) and ODic(1)) of the Y, M and C color components, respectively, were measured by means of Spectrolino (product of Gretag Macbeth, light source: D₆₅, viewing angle: 2°, status A). The results obtained are summarized in Table 3.

ODimax(1) and ODimin(1) were determined from the post-test optical densities of the Y, M and C color components and were evaluated by the following criteria. The results obtained are summarized in Table 3.

ODimax(1)−ODimin(1)≦0.15 A

0.15<ODimax(1)−ODimin(1)≦0.20 B

0.20<ODimax(1)−ODimin(1) C

(3-3) The Optical Density Reduction Ratio of Each Color Component After the Light Fastness Test was Performed

The optical density reduction ratios (Aiy, Aim and Aic) of the Y, M and C color components, respectively, were determined from the initial (pre-test) optical densities determined in (3-1) and the post-test optical densities determined in (3-2). The results obtained are summarized in Table 3.

(3-4) Overall Evaluation

The black dye ink of each of Examples 1 to 7 and Comparative Examples 1 to 6 was evaluated by the following criteria. The results obtained are summarized in Table 3.
Excellent: The evaluation results in (3-1) and (3-2) are both “A,” and all of Aiy, Aim and Aic are 15% or less.
Very Good: The evaluation results in (3-1) and (3-2) are both “A,” and all of Aiy, Aim and Aic are greater than 15% and 20% or less.
Good: The evaluation results in (3-1) and (3-2) are both “A,” but any of Aiy, Aim and Aic exceeds 20%.
Not Good: Any of the evaluation results in (3-1) and (3-2) is “B” or “C.”

TABLE 3

| | | | Example | | | | | | |
|---|---|---|---|---|---|---|---|---|---|
| | | | 1 | 2 | 3 | 4 | 5 | 6 | 7 |
| Composition | Coloring agents used in | | Bk-1 | Bk-2 | Bk-1 | Bk-2 | DB154 | FB2 | FB2 |
| | black dye ink | | DY132 | DY132 | DY132 | DY169 | DY132 | AY23 | DY132 |
| | | | M-1 | M-2, M-5 | M-6 | M-3 | M-7 | M-5 | M-6 |
| | Weight ratio of dyes (black dye/ | | 56/44 | 56/44 | 60/40 | 64/36 | 88/12 | 82/18 | 82/18 |
| | color dyes) | | | | | | | | |
| Before light | Optical density | Y component | 0.97 | 0.98 | 0.94 | 1.01 | 0.87 | 1.01 | 0.91 |
| fastness test | | (ODiy(0)) | | | | | | | |
| | | M component | 1.01 | 1.03 | 1.06 | 1.00 | 0.92 | 1.07 | 1.00 |
| | | (ODim(0)) | | | | | | | |
| | | C component | 0.96 | 0.98 | 1.02 | 1.00 | 1.02 | 1.02 | 0.95 |
| | | (ODic(0)) | | | | | | | |
| | ODimax(0) − ODimin(0) | | 0.05 | 0.05 | 0.12 | 0.01 | 0.15 | 0.06 | 0.09 |
| | Evaluation | | A | A | A | A | A | A | A |
| After light | Optical density | Y component | 0.93 | 0.93 | 0.85 | 0.92 | 0.36 | 0.84 | 0.82 |
| fastness test | | (ODiy(1)) | | | | | | | |
| | | M component | 1.00 | 1.00 | 1.00 | 0.96 | 0.35 | 0.90 | 0.82 |
| | | (ODim(1)) | | | | | | | |
| | | C component | 0.85 | 0.86 | 0.85 | 0.81 | 0.21 | 0.75 | 0.67 |
| | | (ODic(1)) | | | | | | | |

| | | | | | | | |
|---|---|---|---|---|---|---|---|
| ODimax(1) − ODimin(1) | 0.15 | 0.14 | 0.15 | 0.15 | 0.15 | 0.15 | 0.15 |
| Evaluation | A | A | A | A | A | A | A |

| | | | | | | | | |
|---|---|---|---|---|---|---|---|---|
| Optical density reduction | Y component | 4.1% | 5.1% | 9.6% | 8.9% | 58.6% | 16.8% | 9.9% |
| ratio after light fastness | (Aiy) | | | | | | | |
| test | M component | 1.0% | 2.9% | 5.7% | 4.0% | 62.0% | 15.9% | 18.0% |
| | (Aim) | | | | | | | |
| | C component | 11.5% | 12.2% | 16.7% | 19.0% | 79.4% | 26.5% | 29.5% |
| | (Aic) | | | | | | | |

| | | | | | | | |
|---|---|---|---|---|---|---|---|
| Overall evaluation | Excellent | Excellent | Very | Very | Good | Good | Good |
| | | | Good | Good | | | |

| | | | Comparative Example | | | | | |
|---|---|---|---|---|---|---|---|---|
| | | | 1 | 2 | 3 | 4 | 5 | 6 |
| Composition | Coloring agents used in | | Bk-1 | Bk-2 | Bk-1 | AB24 | DB19 | FB2 |
| | black dye ink | | AY23 | DY86 | DY86 | DY132 | DY132 | DY86 |
| | | | M-1 | M-2 | M-3 | M-7 | M-5 | M-4 |
| | Weight ratio of dyes (black dye/ | | 57/43 | 50/50 | 57/43 | 94/6 | 96/4 | 79/21 |
| | color dyes) | | | | | | | |
| Before light | Optical density | Y component | 0.86 | 0.97 | 0.93 | 0.96 | 0.77 | 1.03 |
| fastness test | | (ODiy(0)) | | | | | | |
| | | M component | 0.96 | 1.13 | 1.01 | 0.99 | 0.92 | 1.04 |
| | | (ODim(0)) | | | | | | |
| | | C component | 0.96 | 1.00 | 1.00 | 1.00 | 1.02 | 0.99 |
| | | (ODic(0)) | | | | | | |
| | ODimax(0) − ODimin(0) | | 0.10 | 0.16 | 0.08 | 0.04 | 0.25 | 0.05 |
| | Evaluation | | A | B | A | A | C | A |
| After light | Optical density | Y component | 0.70 | 0.91 | 0.87 | 0.52 | 0.70 | 0.90 |
| fastness test | | (ODiy(1)) | | | | | | |
| | | M component | 0.94 | 1.10 | 0.98 | 0.36 | 0.75 | 0.88 |
| | | (ODim(1)) | | | | | | |
| | | C component | 0.80 | 0.81 | 0.80 | 0.23 | 0.77 | 0.68 |
| | | (ODic(1)) | | | | | | |

| | | | | | | |
|---|---|---|---|---|---|---|
| ODimax(1) − ODimin(1) | 0.24 | 0.29 | 0.18 | 0.29 | 0.07 | 0.22 |
| Evaluation | C | C | B | C | A | C |

| | | | | | | | |
|---|---|---|---|---|---|---|---|
| Optical density reduction | Y component | 18.6% | 6.2% | 6.5% | 45.8% | 9.1% | 12.6% |
| ratio after light fastness | (Aiy) | | | | | | |
| test | M component | 2.1% | 2.7% | 3.0% | 63.6% | 18.5% | 15.4% |
| | (Aim) | | | | | | |
| | C component | 16.7% | 19.0% | 20.0% | 77.0% | 24.5% | 31.3% |
| | (Aic) | | | | | | |

| | | | | | | |
|---|---|---|---|---|---|---|
| Overall evaluation | Not | Not | Not | Not | Not | Not |
| | Good | Good | Good | Good | Good | Good |

(4) Evaluation of the Black Dye Solutions

(4-1) Measurement of the Optical Density of Each Color Component Before the Light Fastness Test is Performed

As an evaluation sample for this (4-1) Measurement, a solid-printed portion printed with a black dye solution was selected from the solid-printed portions in the evaluation sample (gradation sample) printed in (2) above, such that the optical density of at least one color component of the Y, M and C color components is about 0.9 or more and about 1.1 or less, and a color component with the highest optical density is included in the solid-printed portion printed with a black dye solution. Then, the initial (pre-test) optical densities (ODdy(0), ODdm(0) and ODdc(0)) of the Y, M and C color components, respectively, were measured by means of Spectrolino (product of Gretag Macbeth, light source: D₆₅, viewing angle: 2°, status A). The results obtained are summarized in Table 2.

(4-2) Measurement of the Optical Density of Each Color Component After the Light Fastness Test was Performed

Each of the evaluation samples used in (4-1) above was subjected to a light fastness test by means of a high energy xenon weather meter (SC780-WN, product of Suga Test Instruments Co., Ltd.). Specifically, light generated by a xenon lamp was made to pass through a light source lamp filter made of silica glass, a silica glass-based inner filter and a glass-based outer filter which blocks light with a wavelength of 320 nm or less. The resultant light was projected onto the evaluation sample for 100 hours at a temperature of 25° C., a humidity of 50% RH and an illuminance of 93 klux. After the light fastness test was completed, the post-test optical densities (ODdy(1), ODdm(1) and ODdc(1)) of the Y, M and C color components, respectively, were measured by means of Spectrolino (product of Gretag Macbeth, light source: D₆₅, viewing angle: 2°, status A). The results obtained are summarized in Table 2.

(4-3) The Optical Density Difference of Each Color Component Before and After the Light Fastness Test was Performed

The optical density differences (ΔODdy, ΔODdm and ΔODdc) of the Y, M and C color components, respectively, were determined from the initial (pre-test) optical densities determined in (4-1) and the post-test optical densities determined in (4-2). The results obtained are summarized in Table 3.

(Discussion)

In each of Examples 1 to 7 and Comparative Examples 1 to 6, a color component giving the maximum optical density (OD value) in the black dye used was the C color component. Therefore, a yellow dye and a magenta dye, in combination with the black dye, were used as the color dyes for toning.

In each of Examples 1 and 2, the difference between the maximum and minimum optical densities of the optical densities of the color components was 0.15 or less both before and after the light fastness test was performed on the evaluation sample. Therefore, the color balance was excellent both before and after the light fastness test was performed. Moreover, the OD reduction ratio after the light fastness test was performed was 15% or less for all the color components, and the light fastness was very good.

In each of Examples 3 and 4, the difference between the maximum and minimum optical densities of the optical densities of the color components was 0.15 or less both before and after the light fastness test was performed on the evaluation sample. Therefore, the color balance was excellent both before and after the light fastness test was performed. However, the OD reduction ratio of the cyan color component after the light fastness test was performed was slightly larger than 15%. Therefore, the light fastness was lower than that in Examples 1 and 2 but was practically acceptable.

In each of Examples 5 to 7, the difference between the maximum and minimum optical densities of the optical densities of the color components was 0.15 or less both before and after the light fastness test was performed on the evaluation sample. Therefore, the color balance was excellent both before and after the light fastness test was performed. Furthermore, the OD reduction ratio after the light fastness test was performed was much greater than 15% for all the color components except for the Y color component in Example 7. Therefore, the light fastness was poorer than that in Examples 1 and 2, but the color balance was practically acceptable as described above.

In Comparative Example 1, the difference between the maximum and minimum optical densities of the optical densities of the color components was 0.15 or less before the light fastness test was performed on the evaluation sample. Therefore, the color balance was excellent before the light fastness test was performed. However, the optical densities of the Y and C color components decreased significantly after the light fastness test was performed, and the difference between the maximum and minimum optical densities exceeded 0.15. Therefore, the color balance after the light fastness test was performed was problematic.

In Comparative Example 2, the difference between the maximum and minimum optical densities of the optical densities of the color components exceeded 0.15 before the light fastness test was performed on the evaluation sample, and the difference after the light fastness test was performed was much greater than 0.15. Therefore, the color balance was problematic both before and after the light fastness test was performed.

In each of Comparative Examples 3 and 4, the difference between the maximum and minimum optical densities of the optical densities of the color components was 0.15 or less before the light fastness test was performed on the evaluation sample, but the difference between the maximum and minimum optical densities exceeded 0.15 after the light fastness test was performed. Therefore, the color balance was problematic after the light fastness test was performed.

In Comparative Example 5, the difference between the maximum and minimum optical densities of the optical densities of the color components exceeded 0.15 before the light fastness test was performed on the evaluation sample. Therefore, the color balance was problematic before the light fastness test was performed.

In Comparative Example 6, the difference between the maximum and minimum optical densities of the optical densities of the color components was 0.15 or less before the light fastness test was performed on the evaluation sample. Therefore, the color balance was excellent before the light fastness test was performed. However, the color balance exceeded 0.15 after the light fastness test was performed, and the color balance was problematic after the light fastness test was performed.

What is claimed is:

1. A black dye ink for ink-jet recording comprising a black dye, a color dye for toning, a water-soluble organic solvent and water, wherein
in a solid-printed portion printed on glossy paper with the black dye ink and having an average optical density of about 0.9 or more and about 1.1 or less, the following inequalities (1) and (2) are satisfied simultaneously:
ODimax(0)−ODimin(0)≦0.15 (1)
ODimax(1)−ODimin(1)≦0.15 (2)
where ODimax(0) and ODimin(0) are a maximum optical density and a minimum optical density, respectively, of ODiy(0), ODim(0) and ODic(0) which are optical densities of yellow, magenta and cyan color components, respectively; and
ODimax(1) and ODimin(1) are a maximum optical density and a minimum optical density, respectively, of ODiy(1), ODim(1) and ODic(1) which are optical densities of the yellow, magenta and cyan color components, respectively, after a predetermined light fastness test is performed on the solid-printed portion printed with the black dye ink.

2. A black dye ink for ink-jet recording according to claim 1, wherein,
in a solid-printed portion which is printed on glossy paper with a black dye solution containing the black dye, the water-soluble organic solvent and water, removing the color dye for toning from the constitutional components of the black dye ink,
the black dye to be contained in the black dye ink is a black dye contained in the black dye solution being such that a color component giving ΔODdmax agrees with a color component giving ODdmax(0), where ODdmax(0) is a maximum optical density of ODdy(0), ODdm(0) and ODdc(0) which are optical densities of the yellow, magenta and cyan color components, respectively, and where ΔODdmax is a maximum optical density difference value of ΔODdy, ΔODdm and ΔODdc defined by the following equations (3) to (5):
ΔODdy=ODdy(0)−ODdy(1) (3)
ΔODdm=ODdm(0)−ODdm(1) (4)
ΔODdc=ODdc(0)−ODdc(1) (5)
where ODdy(1), ODdm(1) and ODdc(1) are optical densities of the yellow, magenta and cyan color components, respectively, after a predetermined light fastness test is performed on the solid-printed portion printed with the black dye solution.

3. A black dye ink for ink-jet recording according to claim 1, wherein the color component giving ΔODdmax is the cyan color component.

4. A black dye ink for ink-jet recording according to claim 1, wherein an amount of the black dye is about 50 wt. % or more with respect to the total amount of the black dye and the color dye for toning.

5. A black dye ink for ink-jet recording according to claim 1, wherein the color dye for toning is a yellow dye.

6. A black dye ink for ink-jet recording according to claim 1, wherein the color dye for toning is a magenta dye.

7. A black dye ink for ink-jet recording according to claim 1, wherein the color dye for toning is a cyan dye.

8. A black dye ink for ink-jet recording according to claim 1, wherein the color dye for toning is a combination of a yellow dye and a magenta dye.

9. A black dye ink for ink-jet recording according to claim 1, wherein the color dye for toning is a combination of a yellow dye, a magenta dye and a cyan dye.

10. A black dye ink for ink-jet recording according to claim 1, wherein all of Aiy, Aim and Aic defined by the following equations (6) to (8) are 20% or less:
Aiy=[(ODiy(0)−ODiy(1))/ODiy(0)]×100 (6)
Aim=[(ODim(0)−ODim(1))/ODim(0)]×100 (7)
Aic=[(ODic(0)−ODic(1))/ODic(0)]×100 (8).
